(19) United States
(12) Patent Application Publication
(10) Pub. No.: US 2006/0151531 A1
(43) Pub. Date: Jul. 13, 2006

(54) Apparatus and methods for mixing caulk and colorant

(76) Inventor: Daniel J. Tikusis, Englewood, CO (US)

Correspondence Address: FAEGRE & BENSON LLP;Attn: PATENT DOCKETING, 2200 WELLS FARGO CENTER, 90 SOUTH 7TH STREET, MINNEAPOLIS, MN, 55402-3901, US

(21) Appl. No.: 11/035,251

(22) Filed: Jan. 13, 2005

(51) Int. Cl. B67D 5/60

(52) U.S. Cl. 222/145.6

(57) ABSTRACT

Apparatus for mixing caulk with colorant comprising a first compartment having a predetermined amount of caulk provided or placed therein; a second compartment having a predetermined amount of colorant provided or placed therein; a mixer in fluid communication with the two compartments; a discharger to discharge the caulk and the colorant from the compartments into the mixer, wherein the caulk and the colorant are mixed such that the colorant tints the caulk as it is dispensed. A method for mixing caulk with colorant comprising providing or placing a predetermined amount of caulk in a first compartment; providing or placing a predetermined amount of colorant in a second compartment; providing a mixer in fluid communication with the compartments; discharging the caulk and the colorant from the compartments into the mixer, and mixing the caulk and the colorant such that the colorant tints the caulk as it is dispensed.

### BACKGROUND OF THE INVENTION

1. Field of the Invention

The present invention relates generally to apparatus and methods for mixing and dispensing caulk and more particularly to mixing caulk with a colorant while the caulk is being dispensed.

2. Discussion of the Background

Caulk is used to join or seal, for example, wood or synthetic trim to painted surfaces; laminates at their seams or to walls; sinks to counters; shower stalls and tubs to walls, flooring to painted, laminated, or wood surfaces; and so on. Caulk is generally used to caulk joints where a waterproof seal is needed in the joint and that can be subsequently painted if necessary. Most caulks are generally clear, white, or off-white tending toward a gray color that is the natural color of most caulk, although some limited quantities of black or special order quantities of colors are available. The colored caulks, i.e., those other than white, cannot generally be commercially obtained except in very large quantities upon special order from the manufacturer. There is not a great deal of demand for large quantities of particular unique colors of colored caulk, and it is therefore impractical for a caulk manufacturer to produce large quantities of tinted caulk having various colors and shades.

Therefore, such tinted caulk is generally not available for small users such as homeowners, handymen, and smaller commercial construction companies whose volume of use is not sufficient to warrant special orders of a particular tinted color of caulk. There is a desire, however, on the part of the purchasing public or end user to have caulk of various colors.

In the use of certain materials such as caulk or other sealing materials that are sold in plastic dispensing tubes, it is often desirable to color the caulk to match, e.g., the wall color being applied to a room. For example, in the use of conventional white caulk, as soon as the caulk sets up sufficiently, usually about two hours or longer, the caulk can be painted the same color as the abutting surface. Where the paint is of a light shade, it may be difficult to cover the caulk completely without multiple paint coats. Also, it is often necessary to do some additional caulking after the final coat of paint is applied. In that event, the caulk is painted over as the final step. The advantage of having color-matched caulk is that a great saving of time and effort is possible. The user does not have to apply the paint itself with precision at joining edges or, alternatively, does not have to paint over white caulk previously applied. The user may first paint next to, but not exactly on, the joint and then afterwards fill in the unpainted surface with caulk tinted to match the paint color. A further advantage is aesthetic. Color-matched caulk will be nearly invisible to the viewer, thus providing an attractive aspect to the interior and exterior of the building.

Consequently, some paint dealers have undertaken to mix colorant into caulk by hand for certain customers, but considerable time and effort is involved and often results in inferior mixing and considerable clean-up time. The problem is that, unlike paint, caulk is very viscous. Therefore, there are difficulties in mixing the tinting agent with the caulk and in dispensing the caulk into the tubes that are used in caulk guns, since it cannot readily be poured. There is presently no economical means available of supplying this needed product since manufacturers of caulk cannot maintain sufficient variety of inventory of small quantities of colored caulk to suit consumer needs.

Many attempts have been made to provide an apparatus and method by which caulk can be easily tinted to match a particular paint color. For example, an apparatus has been developed to mix caulk and paint together inside a standard caulk cartridge (U.S. patent application Publication No. 2003/0099153). First, the cartridge piston is removed from the cartridge. Paint is removed from the paint can with a syringe and inserted into the cartridge. A mixer propeller is then connected to the caulk cartridge and pushed down the inside of the cartridge through the caulk. After a pressure cap is connected to the cartridge, the mixer propeller is then pushed up and down the cartridge several times while being rotated. The pressure cap and mixer propeller are then removed, and the piston is replaced on the cartridge. This apparatus and method require considerable force and may not mix the paint thoroughly into the caulk, leaving portions either not tinted at all or only partially tinted. The method also requires the user to purchase and attach and detach additional components to the cartridge, taking time and effort and exposing the user to the possibility of spilling caulk over himself or over nearby items.

In another attempt to provide caulk of a desired color, the apparatus and method in U.S. Pat. No. 5,044,758 have been developed. In this apparatus, the apparatus includes a caulk jar for holding uncolored caulk and for receiving unmixed pigment. Empty caulk tubes are attached to a transfer lid. A mix lid includes a rotatable blade. The mix lid is attached to the caulk jar. The two lids and then attached to a machine that mixes the pigment and caulk in the caulk jar and transfers the mixture to the caulk tubes.

In another apparatus and method shown in U.S. patent application Publication No. US 2002/0065353, a pigmented composition is added to a container of a caulk-forming composition, and the container is then placed into and shaken by a shaking apparatus. The shaking action causes the caulk and pigment to thicken to form a colored caulking material. Several containers can be shaken at one time. A similar method is disclosed in U.S. Pat. No. 4,114,196. In these methods, the user must again purchase additional components (the shaker) that add expense.

In all the prior methods of tinting caulk, the caulk must be tinted in a separate operation before it is dispensed from the caulk container. This results in additional time, effort, and expense on the part of the user. In many instances, the apparatus used may not completely mix the colorant with the caulk, leading to an unacceptable product and the need to repeat the mixing process.

Thus, there is a need for an apparatus and method that allows the contractor or the home handyman to purchase tubes of caulk and mix colorant with the caulk to duplicate the color of their paint, tile, laminate, or the like. There is also a need for a quick, effective, convenient, and cleaner method and apparatus for substantially automatically performing the mixing operation while the caulk is being dispensed.

### SUMMARY OF THE INVENTION

The present invention comprises an apparatus for mixing caulk with colorant. In one embodiment, the apparatus comprises a container containing a caulk and a colorant; a mixer in fluid communication with the container; a discharger to discharge the caulk and the colorant from the container into the mixer, the mixer mixing the caulk with the colorant such that the colorant tints the caulk as both move through the mixer. The mixer is a static mixer, or motionless mixer, comprising a plurality of baffles. Thus, the colorant is tinted to the desired color as it is being dispensed from the container by the user who is applying the caulk to the surface.

The ratio of caulk to colorant is such that the colorant tints the caulk to the color desired by the user. In most embodiments, the color desired is identical to the color of the colorant.

The caulk is selected from a wide variety of materials such as sealants and adhesives, grouts, mortars, silicious or cementitious materials, wood filler, wood putty, viscous compounds and lubricating materials, paints, colors, and colorants, and even food materials. Sealants and adhesives also comprise reactive-type materials in which two substances are mixed and a chemical reaction between them causes the final material to set. The colorant is selected from a wide variety of materials such as paints, dyes, stains, pigments, varnishes, lacquer, colored aggregate or colored granules (e.g., sand, plastic granules, ceramic-coated granules, mineral aggregates), and food coloring.

In one embodiment, the apparatus comprises a first compartment having a predetermined amount of caulk provided therein; a second compartment having a predetermined amount of colorant provided therein; a mixer in fluid communication with the first compartment and the second compartment; a discharger for discharging the caulk and the colorant into the mixer, the mixer mixing the caulk with the colorant as the caulk and the colorant pass through the mixer such that the colorant tints the caulk.

In another embodiment, the apparatus for mixing caulk with colorant comprises a first container having a predetermined amount of caulk provided therein; a second container having a space into which a predetermined amount of colorant is placed; a mixer in fluid communication with the first container and the second container; a discharger to discharge the caulk and the colorant from the container into the mixer, the mixer mixing the caulk with the colorant such that the colorant tints the caulk as both move through the mixer. In this embodiment, the user of the apparatus, which already is provided with caulk, places the colorant into the second container by any method known to those skilled in the art, for example, with a syringe.

In another embodiment, the caulk and colorant are provided in an apparatus having at least two containers, a first container for the caulk and a second container for the colorant. Each container has an outlet opening at the same end of the dispenser. A mixer is in fluid communication with the outlet openings of the containers. By the use of a discharger, the caulk and the colorant are discharged from the containers through the outlet openings into the mixer. As the caulk and colorant move through the mixer, they are combined such that the caulk, upon exiting the mixer, has been tinted to a color identical to the colorant color.

In one form of this embodiment, the first container of the apparatus is preloaded with caulk, and the second container of the apparatus is preloaded with colorant. In this embodiment, the end user need only use a discharger to discharge the caulk and colorant into the mixer to tint the caulk.

In another form of this embodiment, the first container of the apparatus is provided with caulk. The colorant is placed into a second container of the dispenser by the end user. This can be done by placing the colorant into the second container with, for example, a syringe.

In another form of this embodiment, the end user of the dispenser places caulk into the first container and places colorant into the second container.

The present invention comprises a method for mixing colorant with caulk. In one embodiment, the method comprises the steps of providing a container containing a caulk and a colorant; providing a mixer in fluid communication with the container; discharging the caulk and the colorant from the container into the mixer, the mixer mixing the caulk with the colorant such that the colorant tints the caulk as both move through the mixer. Thus, the colorant is tinted to the desired color as it is being dispensed from the mixer by the user who is applying the caulk to the surface.

In one embodiment, the method comprises providing a first compartment having a predetermined amount of caulk provided therein; providing a second compartment having a predetermined amount of colorant provided therein; providing a mixer in fluid communication with the first compartment and the second compartment; discharging the caulk and the colorant into the mixer, the mixer mixing the caulk with the colorant as the caulk and the colorant pass through the mixer such that the colorant tints the caulk.

In another embodiment, the method for mixing caulk with colorant comprises providing a first container having a predetermined amount of caulk provided therein; providing a second container having a space; placing a predetermined amount of colorant into the space; providing a mixer in fluid communication with the first container and the second container; discharging the caulk and the colorant from the containers into the mixer, the mixer mixing the caulk with the colorant as the caulk and the colorant pass through the mixer such that the colorant tints the caulk as both move through the mixer. In this embodiment, the user of the apparatus, which already is provided with caulk, places the colorant into the second container by any method known to those skilled in the art, for example, with a syringe.

In another embodiment, the method comprises the steps of providing an apparatus having at least two containers, each of the at least two containers having an outlet opening; providing a caulk in a first of the at least two containers; providing a colorant in a second of the at least two containers; providing a mixer in fluid communication with the outlet openings of the first and the second containers; discharging the caulk and the colorant from the first and the second containers through the outlet openings into the mixer, wherein the caulk and the colorant are mixed as the caulk and the colorant pass through the mixer such that the colorant tints the caulk.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a perspective view showing a container of the present invention mounted on a discharger.

FIG. 2 is a cross-sectional view of the apparatus of the present invention.

FIG. 3 is a cross-sectional view of a prior art mixer with a portion expanded to show the baffles.

FIG. 4 is a cross-sectional view of the apparatus of the present invention illustrating a space where the colorant is placed.

FIG. 5 is a cross-sectional view showing the placing of the colorant into the space of FIG. 4.

FIG. 6 is a cross-sectional view of one embodiment of the present invention.

FIG. 7 is a cross-sectional view of another embodiment of the present invention.

FIG. 8 is a flow chart describing a method of the present invention.

FIG. 9 is a flow chart describing a method of the present invention.

FIG. 10 is a flow chart describing a method of the present invention.

FIG. 11 is a flow chart describing a method of the present invention.

FIG. 12 is a flow chart describing a method of the present invention.

FIG. 13 is a flow chart describing a method of the present invention.

FIG. 14 is a flow chart describing a method of the present invention.

### DETAILED DESCRIPTION OF THE INVENTION

The term “caulk” is used throughout the application, but it will be readily understood that the invention is not limited to any one particular material, and that the material being tinted can be selected from a wide variety of materials such as sealants and adhesives, grouts, chemically reactive resins (for example, epoxy resins and a hardener, or polyester resins and a catalyst; in this application, all types of chemically reactive resins are called “resin” and all types of hardener or catalysts used with such resins are called “curing agents”), mortars, silicious or cementitious materials, wood filler, wood putty, viscous compounds and lubricating materials, paints, colors, and colorants, and even food materials.

Similarly, the term “colorant” is used throughout the application, but it will be readily understood that the invention is not limited to any one particular material, and that the material being used as a colorant can be selected from a wide variety of materials such as paints, dyes, stains, pigments, varnishes, lacquer, colored aggregate or colored granules (e.g., sand, plastic granules, ceramic-coated granules, mineral aggregates), and food coloring.

Apparatus

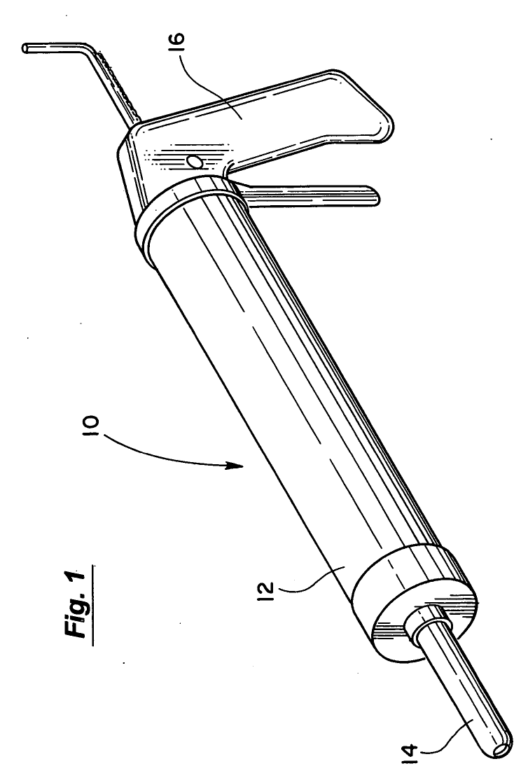

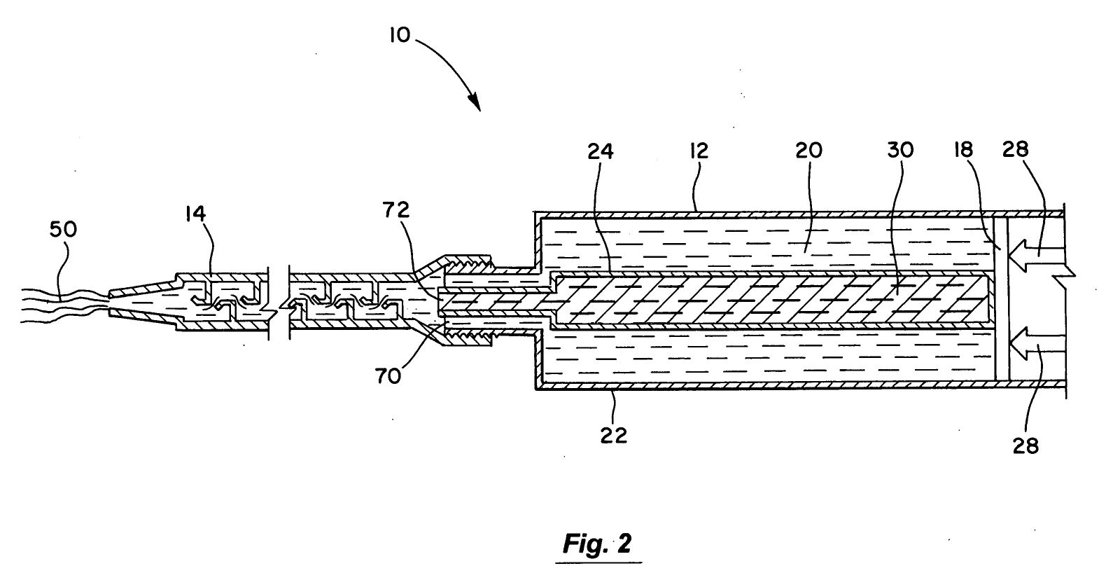

In FIG. 1 the apparatus of the present invention is indicated generally at 10. A container 12 contains caulk and colorant (not shown). A mixer 14 is in fluid communication with the container 12. The container 12 is shown mounted in a conventional discharger 16 to discharge the caulk and the colorant from the container 12 into the mixer 14. Although a particular type of discharger 16 is disclosed in FIG. 1, it is to be understood that any discharger 16 that discharges the caulk and the colorant from the container 12 is comprised by the present invention. In FIG. 1, for example, the discharger 16 is a conventional caulk gun having a piston 18 (shown in FIG. 2). For example, the linear force applied by the piston 18 required to operate the discharger 16 can be applied manually, pneumatically, hydraulically, by threadedly advancing an actuating screw, or various other types of mechanisms. In another example, but not limited to, the container 12 is nonrigid and the discharger 16 is a clamp (not shown) that is clamped to the end of the container 12. As the clamp slides down the container 12 toward the mixer 14, or, alternatively, is rolled up toward the mixer 14, the caulk and colorant are discharged into the mixer 14. Other types of dischargers 16 suitable for use with the present invention will be evident to those skilled in the art without undue experimentation.

As shown in more detail in FIG. 2, the apparatus 10 of the present invention comprises a container 12 containing a caulk 20 and a colorant 30; a mixer 14 in fluid communication with the container 12; a discharger (not shown) (with a piston 18) to discharge the caulk 20 and the colorant 30 from the container 12 into the mixer 14, the mixer 14 mixing the caulk 20 with the colorant 30 as the caulk 20 and the colorant 30 pass through the mixer 14 such that the colorant 30 tints the caulk 20 as it is dispensed from the apparatus 10. The discharger 16, except for the piston 18, is removed from FIGS. 2-6 6 for the sake of clarity.

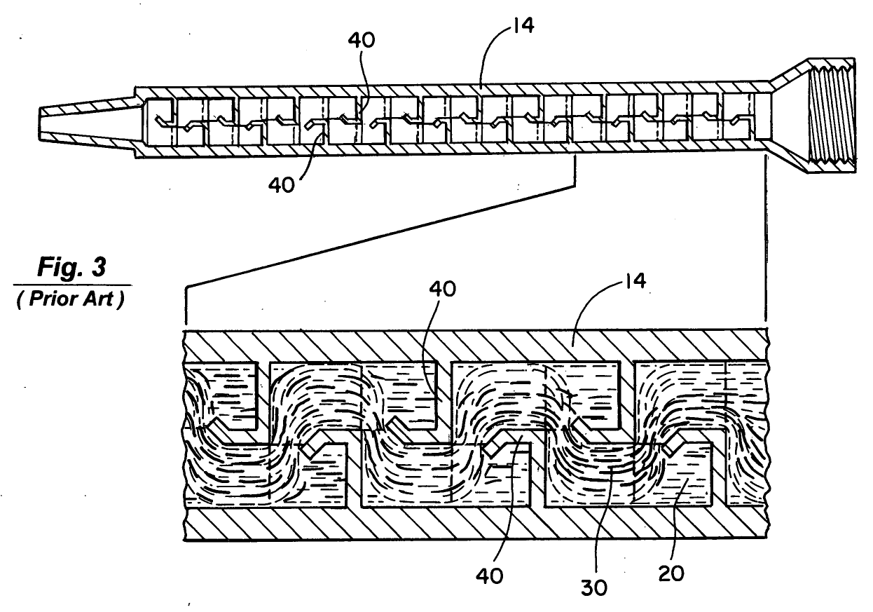

The mixer 14, shown in FIG. 3, is a conventional static mixer having a plurality of baffles 40 therein. In one embodiment of the present invention, a static mixer such as that described in U.S. Pat. No. 6,773,156 is used. The mixer 14 is connected to the container 12 in any manner that enables the mixer 14 to be in fluid communication with the container 12. For example, but not limited to, the mixer 14 is screwed onto the container 12, as shown in FIG. 2, or is snapped on to the container 12 (not shown). In another example (not shown), the mixer 14 is an integral part of the container 12. Other embodiments achieving fluid communication of the mixer 14 with the container 12 will be evident to those skilled in the art and are meant to be included in the present invention.

Although a particular design of mixer 14 is disclosed in FIG. 3, it is to be understood that any type of mixer 14 that achieves a thorough mixing of the caulk 20 with the colorant 30 as the caulk 20 and colorant 30 are discharged from the container 12 is comprised by the present invention.

In more detail, in the embodiment shown in FIG. 2, the apparatus 10 comprises a first container 22 having a predetermined amount of caulk 20 provided therein, and a second container 24 having a predetermined amount of colorant 30 provided therein. The caulk 20 and colorant 30 are thus provided by, for example, the manufacturer of the apparatus 10. A mixer 14 is in fluid communication with the first container 22 and the second container 24. A discharger 16 (not shown) having a piston 18 is used to discharge 28 the caulk 20 and the colorant 30 from the first container 22 and the second container 24, respectively, into the mixer 14, wherein the caulk 20 and the colorant 30 are mixed as the caulk 20 and the colorant 30 pass through the mixer 14 such that the colorant 30 tints the caulk 20. The tinted caulk 50 then exits the mixer 14.

In the embodiment shown in FIG. 2, the caulk 20 and the colorant 30 are provided in predetermined amounts in the container 12 by the manufacturer. The predetermined amounts are any amounts that provide the correct amount of colorant 30 to tint the caulk 20 to the desired color. These predetermined amounts thus provide a predetermined ratio of caulk to colorant. For example, conventional containers 12 often use a predetermined ratio of about 10 to about 1 (by volume) of caulk 20 to colorant 30.

The movement of piston 18 within the container 12 will result in the synchronous discharge of the caulk 20 and the colorant 30 from their respective containers 22, 24 into the mixer 14 in a desired predetermined ratio assuming that both containers 22, 24 are filled as shown in FIG. 2 at the start of the discharging operation.

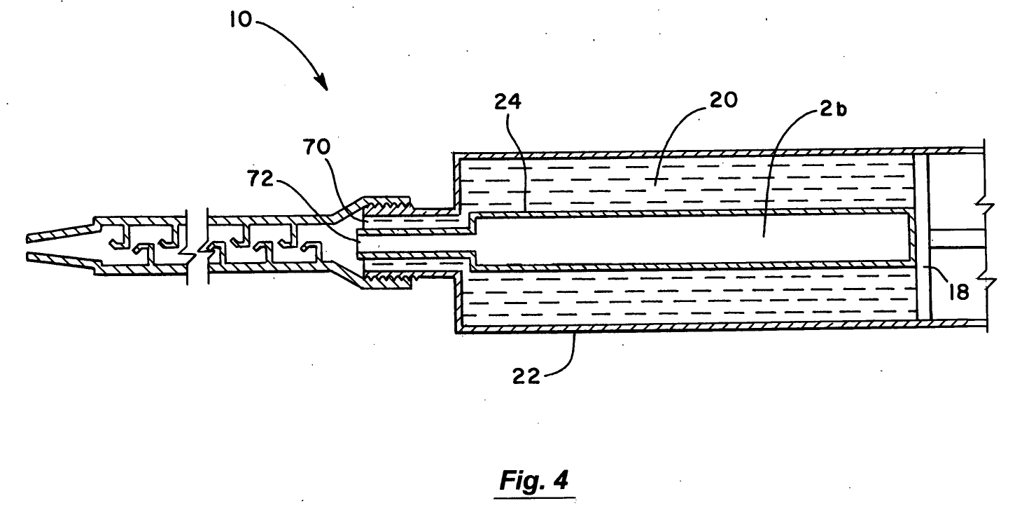

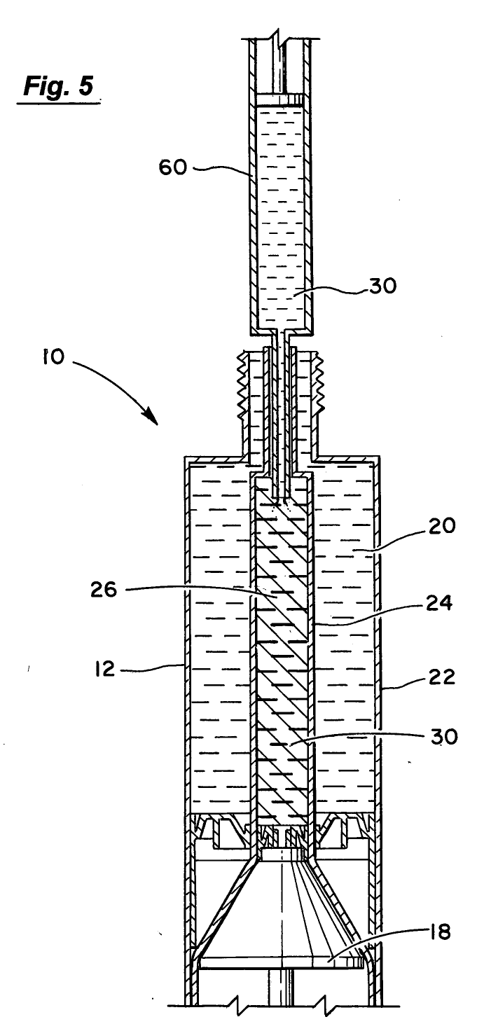

In another embodiment of the present invention, shown in FIG. 4, the apparatus 10 for mixing caulk 20 with colorant 30 comprises a first container 22 having a predetermined amount of caulk 20 provided therein (by the manufacturer of the apparatus 10, for example); a second container 24 having a space 26 into which a predetermined amount of colorant is placed (see FIG. 5); a mixer 14 (not shown) in fluid communication with the first container 22 and the second container 24; a discharger 16 (not shown) having a piston 18 to discharge the caulk 20 and the colorant 30 from the first container 22 and the second container 24 into the mixer 14, wherein the caulk 20 and the colorant 30 are mixed as the caulk 20 and the colorant 30 pass through the mixer 14 such that the colorant 30 tints the caulk 20.

The colorant 30 is placed within the space 26 of the second container 24 by, for example, the end user. This can be done by any method known to those skilled in the art. For example, but not limited to, the colorant 30 is placed within the space 26 of the second container 24 by use of a syringe 60, as shown in FIG. 5. Depending on the design of the container 12, the nozzle 62 of the syringe 60 can be inserted in either end of the second container 24, whichever end is accessible to the end user.

In another embodiment of the present invention, the apparatus 10 comprises at least two containers 22, 24, each of the at least two containers 22, 24 having a respective outlet opening 70, 72, as shown in FIG. 2. A caulk 20 is provided in a first container 22, and a colorant 30 is provided in a second container 24. A mixer 14 is in fluid communication with the outlet openings 70, 72 of the at least two containers 22, 24. The apparatus 10 further comprises a discharger 16 (not shown) having a piston 18 to discharge the caulk 20 and the colorant 30 from the at least two containers 22, 24 into the mixer 14, wherein the caulk 20 and the colorant 30 are mixed as the caulk 20 and the colorant 30 pass through the mixer 14 such that the colorant 30 tints the caulk 20.

The first container 22 and the second container 24 are positioned such that the second container 24 is within the first container 22, either off center (not shown), or concentric or coaxial, as shown in FIGS. 2 and 4. Alternatively, the apparatus 10 comprises at least two containers 22, 24 placed side by side (not shown) or in any other configuration that enables the contents of the containers 22, 24 to be discharged simultaneously into the mixer 14. In some embodiments (not shown), the containers 22, 24 are equal in size; in other embodiments, the containers 22, 24 are of different sizes as in FIG. 4.

In another embodiment of the present invention, the apparatus 10 comprises at least two containers 22, 24, each of the at least two containers 22, 24 having a respective outlet opening 70, 72, as shown in FIG. 4. A first container 22 has a predetermined amount of caulk 20 provided therein (by the manufacturer of the apparatus 10, for example); a second container 24 has a space 26 into which a predetermined amount of colorant is placed as described above and in FIG. 5. The apparatus further comprises a mixer 14 in fluid communication with the outlet openings 70, 72 of the at least two containers 22, 24. The apparatus 10 comprises a discharger 16 (not shown) having a piston 18 to discharge the caulk 20 and the colorant 30 from the at least two containers 22, 24 into the mixer 14, wherein the caulk 20 and the colorant 30 are mixed as the caulk 20 and the colorant 30 pass through the mixer 14 such that the colorant 30 tints the caulk 20.

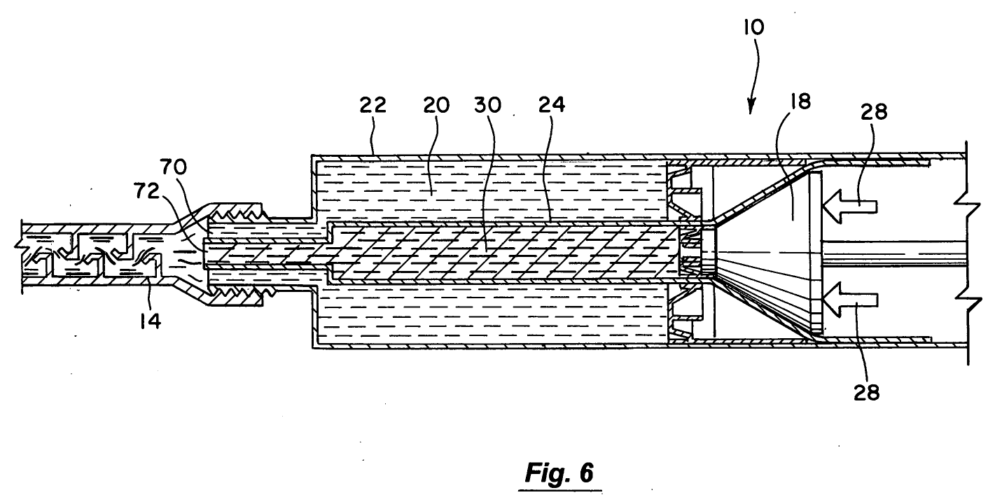

In another embodiment of the present invention, shown in FIG. 6, an apparatus 10 comprises an outer container 22; an inner container 24 concentric to the outer container 22. The outer container 22 and the inner container 24 each have an outlet opening 70, 72, with the outlet opening 72 of the inner container 24 positioned within the outlet opening 70 of the outer container.

Caulk 20 is provided within the outer container 22. The caulk 20 can be provided by being preloaded by the apparatus manufacturer. Alternatively, the end user can place a desired caulk 20 into the outer container 22.

Colorant 30 is provided within the inner container 22. In one embodiment, the colorant 30 is provided by being preloaded by the apparatus manufacturer. In this embodiment, the inner container 22 can be preloaded with, for example, a particular premixed paint color and packaged for sale with cans of the paint. In another embodiment, the colorant 30 is placed into the inner container 22 by the end user, as described above and in FIG. 5. This is useful when the end user has a unique colorant 30 that is not available as a premixed material.

A piston 18 is positioned within the outer container 22. A mixer 14 is in fluid communication with the outlet opening 70 of the outer container 22, the caulk 20 mixing with the colorant 30 when the piston 18 is moved 28 along the outer container 22 and discharges the caulk 20 and the colorant 30 into the mixer 14.

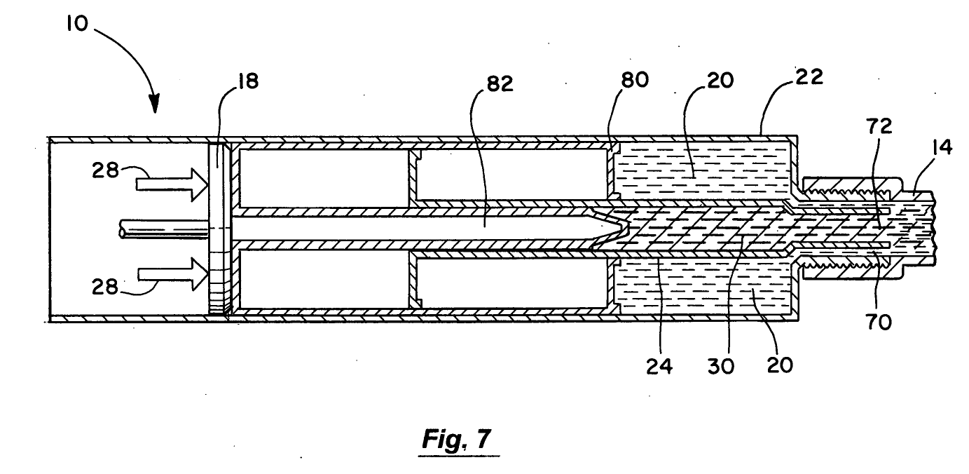

In another embodiment illustrated in FIG. 7, the apparatus 10 comprises first 22 and second 24 containers having hollow interiors 23, 26. A caulk 20 is provided in the first container 22, and a colorant is placed in the second container 24. A plunger 80 is placed within the rear portion of the first container 22 for discharging the caulk 20 and the colorant 30, respectively, from the interiors 23, 26 of the containers 22, 24. Each of the containers 22, 24 has an outlet 70, 72 through which the caulk 20 and the colorant 30 are respectively discharged.

To discharge the caulk 20 and the colorant 30 from the containers 22, 24, the piston 18 is moved forwardly in the direction of arrow 28, and will telescopically slidably move the plunger 80 within the interior of the first container 22. An elongated post 82 extending from the plunger 80 moves into the second container 24 upon movement of the plunger 80 into the first container 22. Upon the forward movement 28 of the plunger 80, the post 82 will start discharging colorant 30 through the outlet 72 of the second container 24 synchronously with the discharge of the caulk 20 through the outlet 70 of the first container 22.

A mixer 14 is in fluid communication with the outlets 70, 72 of the first 22 and second 24 containers for receiving the caulk 20 and colorant 30 upon their discharge from their respective containers 22, 24. The mixer 14 is a static mixer such as shown in U.S. Pat. No. 6,773,156, whereby the caulk 20 and colorant 30 upon entering the mixer 14 are uniformly mixed as they move through the mixer 14, prior to being discharged therefrom.

In another embodiment of the present invention, a resin and a curing agent as defined above are tinted by a colorant. In this embodiment, an apparatus 10 for mixing caulk 20 with colorant 30 comprises a first container 22 having two compartments (not shown). The first compartment has a predetermined amount of resin provided therein, and the second compartment has a predetermined amount of curing agent provided therein. The resin and the curing agent form the caulk 20 in conventional fashion when mixed. The apparatus 10 further comprises a second container 24 having a predetermined amount of colorant 30 provided therein.

A mixer 14 is in fluid communication with the first container 22 and the second container 24 as described hereinabove. A discharger discharges the resin, the curing agent, and the colorant 30 from the first container 22 and the second container 24 into the mixer 14, wherein the resin, the curing agent, and the colorant 30 are mixed such that the colorant 30 tints the caulk 20 as the caulk 20 and the colorant 30 pass through the mixer 14.

Although the above descriptions and drawings show the apparatus 10, and in particular the containers 22, 24 thereof, being cylindrical, it is readily understood that the configuration of the containers 22, 24, as well as the internal volume thereof, may change in order to provide a different ratio between the amounts of caulk 20 and colorant 30 being discharged for subsequent mixing in the mixer 14. For example, the second container 24 may contain less volume than that of the first container 22 so that a smaller amount of the colorant 30 is dispensed for mixing with a larger amount of the caulk 20, depending on the desired tint of subsequent mixed product 50 to be formed thereby.

Accordingly, the apparatus is simplified, provides an effective, safe, inexpensive, and efficient device that achieves all the enumerated objectives, provides for eliminating difficulties encountered with prior devices, and solves problems and obtains new results in the art.

Methods

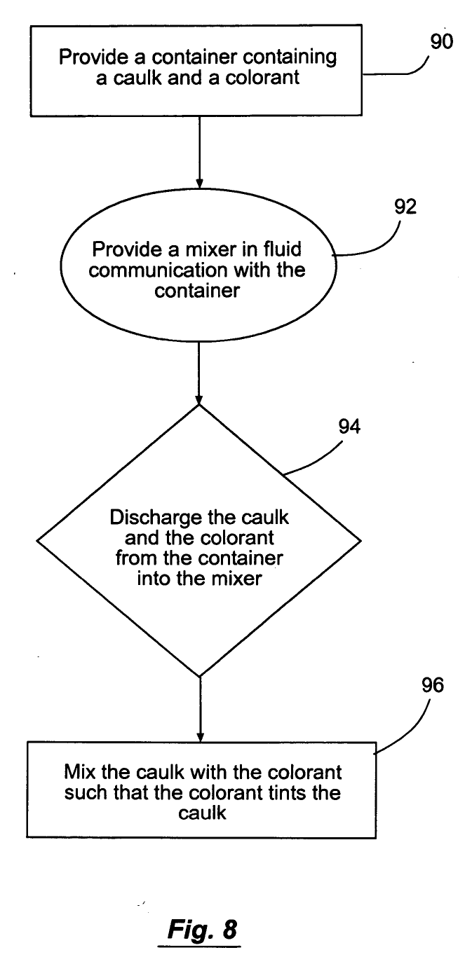

A method for mixing caulk with colorant is illustrated in FIG. 8. The method comprises providing 90 a container containing a caulk and a colorant; providing 92 a mixer in fluid communication with the container; discharging 94 the caulk and the colorant from the container into the mixer; the mixer mixing 96 the caulk with the colorant as the caulk 20 and the colorant 30 pass through the mixer 14 such that the colorant tints the caulk.

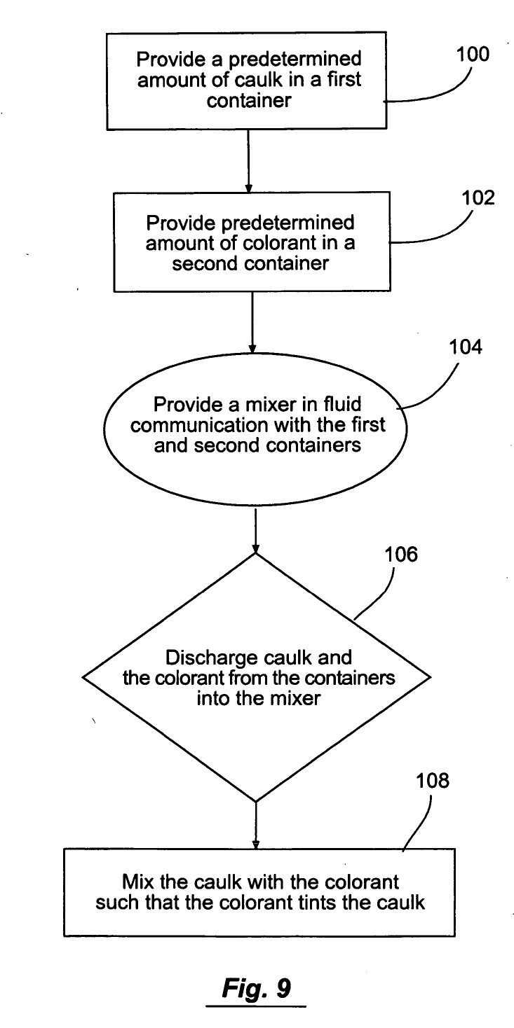

In another embodiment shown in FIG. 9, a method for mixing caulk with colorant comprises providing 100 a predetermined amount of caulk in a first container; providing 102 a predetermined amount of colorant in a second container; providing 104 a mixer in fluid communication with the first container and the second container; discharging 106 the caulk and the colorant from the first container and the second container into the mixer; and mixing 108 the caulk and the colorant by the mixer as the caulk 20 and the colorant 30 pass through the mixer 14 such that the colorant tints the caulk.

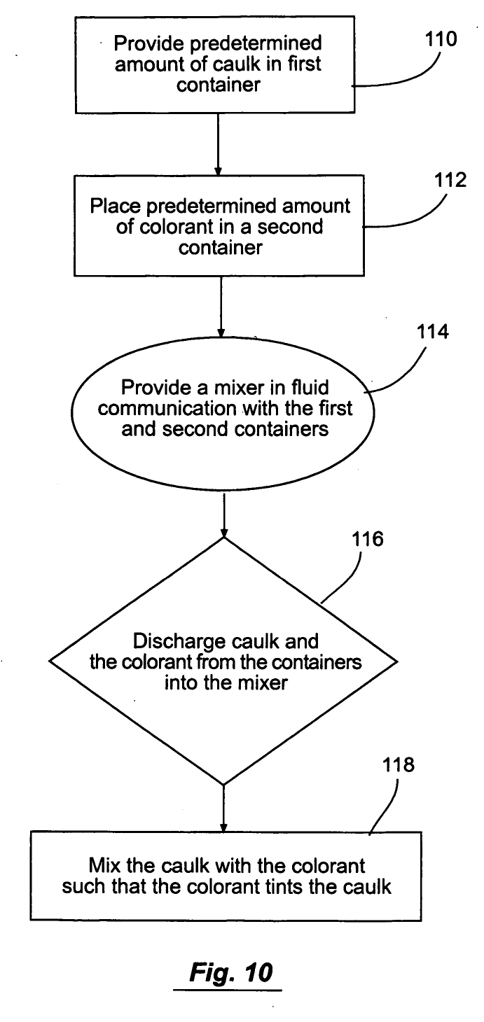

In another embodiment illustrated in FIG. 10, a method for mixing caulk with colorant comprises providing 110 a predetermined amount of caulk in a first container; placing 112 a predetermined amount of colorant in a second container; providing 114 a mixer in fluid communication with the first container and the second container; discharging 116 the caulk and the colorant from the first container and the second container into the mixer; and mixing 118 the caulk and the colorant as the caulk 20 and the colorant 30 pass through the mixer 14 such that the colorant tints the caulk.

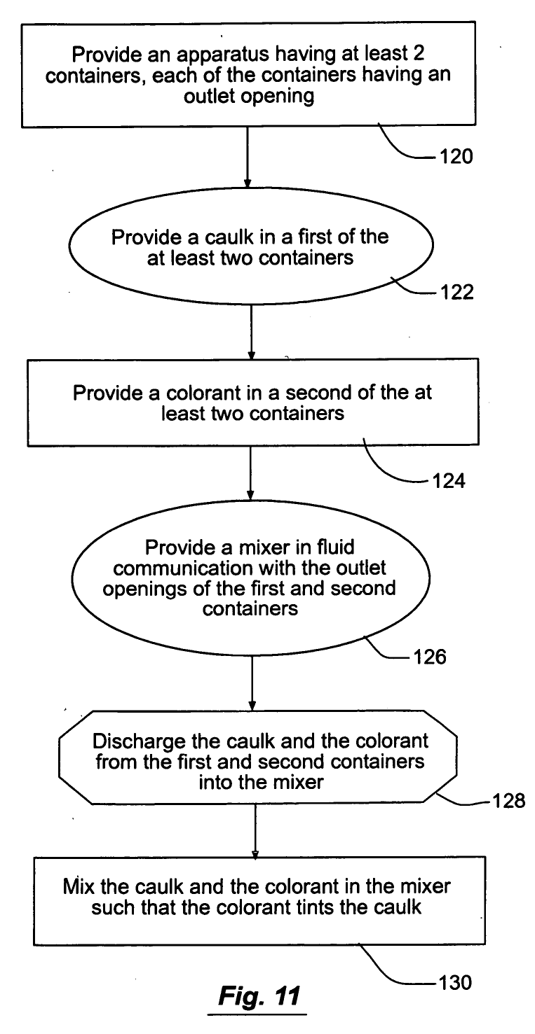

In another embodiment shown in FIG. 11, a method for mixing colorant with caulk comprises providing 120 an apparatus having at least two containers, each of the at least two containers having an outlet opening; providing 122 a caulk in a first of the at least two containers; providing 124 a colorant in a second of the at least two containers; providing 126 a mixer in fluid communication with the outlet openings of the first and the second containers; discharging 128 the caulk and the colorant from the first and the second containers through the outlet openings into the mixer; mixing 130 the caulk and the colorant as the caulk 20 and the colorant 30 pass through the mixer 14 such that the colorant tints the caulk.

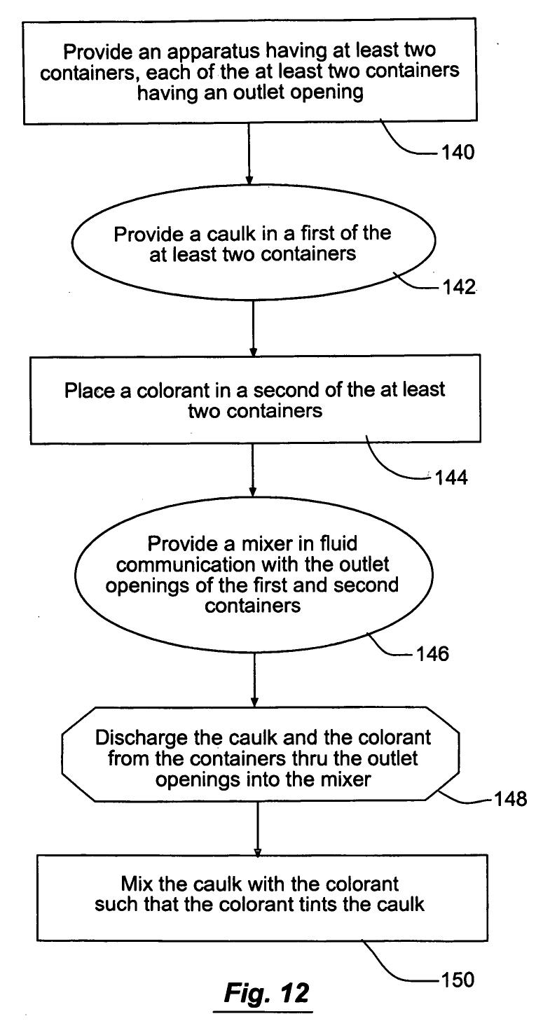

In yet another embodiment disclosed in FIG. 12, a method for mixing colorant with caulk comprises providing 140 an apparatus having at least two containers, each of the at least two containers having an outlet opening; providing 142 a caulk in a first of the at least two containers; placing 144 a colorant in a second of the at least two containers; providing 146 a mixer in fluid communication with the outlet openings of the first and the second containers; discharging 148 the caulk and the colorant from the first and the second containers through the outlet openings into the mixer, and mixing 150 the caulk and the colorant as the caulk 20 and the colorant 30 pass through the mixer 14 such that the colorant tints the caulk.

In this embodiment, the colorant is placed 144 by the end user into the second container with a syringe, as described above and shown in FIG. 5. The end user fills the syringe with the colorant and then inserts the syringe into the second container. The syringe can be inserted into the outlet opening or into the other end of the second container, depending on the apparatus design. Other conventional methods of placing the colorant into the second container will be evident to those skilled in the art.

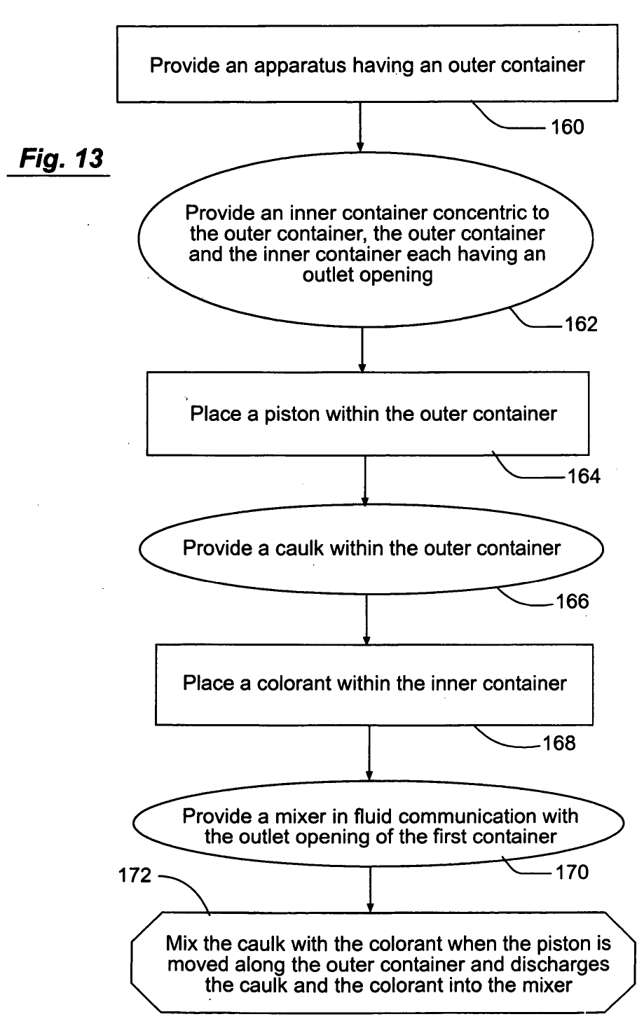

In another embodiment shown in FIG. 13, a method for mixing caulk with colorant comprises providing 160 an apparatus having an outer container; providing 162 an inner container concentric to the outer container; the outer container and the inner container each having an outlet opening, the outlet opening of the inner container positioned within the outlet opening of the outer container; providing 164 a piston within the outer container; providing 166 a caulk within the outer container; placing 168 a colorant within the inner container; providing 170 a mixer in fluid communication with the outlet opening of the outer container; mixing 172 the caulk with the colorant when the piston is moved along the outer container and discharges the caulk and the colorant into the mixer.

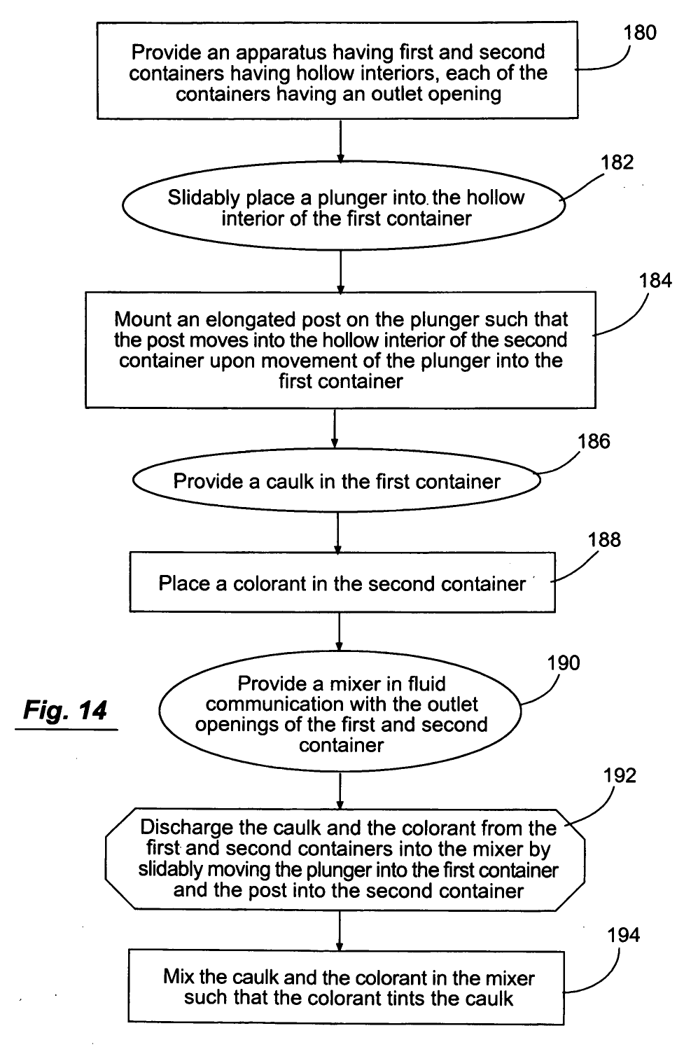

Another method for mixing a caulk 20 with a colorant 30 is illustrated in FIG. 14. This method comprises providing 180 an apparatus 10 having first and second containers having hollow interiors, each of the containers having an outlet opening; slidably placing 182 a plunger into the hollow interior of the first container; mounting 184 an elongated post on the plunger such that the post moves into the hollow interior of the second container upon movement of the plunger into the first container; providing 186 a caulk in the first container; placing 188 a colorant in the second container; providing 190 a mixer in fluid communication with the outlets of the first and second containers for receiving the caulk and the colorant upon discharge from their respective containers; synchronously discharging 192 the caulk and the colorant from the first and second containers by slidably moving the plunger into the first container and the post into the second container; mixing 194 the caulk 20 and the colorant 30 as the caulk 20 and the colorant 30 pass through the mixer 14 such that the colorant 30 tints the caulk 20.

In another method for mixing caulk 20 with colorant 30 comprises providing a first container 22 having two compartments (not shown), the first compartment having a predetermined amount of resin provided therein, and the second compartment having a predetermined amount of curing agent provided therein. The resin and the curing agent form the caulk 20 when mixed.

This method further comprises providing a second container 24 having a predetermined amount of colorant 30 provided therein; providing a mixer 14 in fluid communication with the first container 22 and the second container 24; discharging the resin, the curing agent, and the colorant 30 from the first container 22 and the second container 24 into the mixer 14; mixing the resin and the curing agent with the colorant 30 as the resin, the curing agent, and the colorant 30 pass through the mixer 14 such that the colorant 30 tints the caulk 20.

It is to be understood that the methods of the present invention can be practiced with many containers currently available on the market, for example, but not limited to, the containers described in U.S. patent application Publication No. 2004/0129122 to Brugner et al., U.S. Pat. No. 5,249,709 to Duckworth et al., and U.K. Patent No. 2276365 to Prestele, and with other mixers, for example, but not limited to, the static mixers described in U.S. Pat. No. 6,599,008 to Sulzer Chemtech AG and U.S. patent application Publication No. 2003/0179648 to Heusser et al. and the mixers sold by Conprotec Inc., Salem, N.H., USA, under the mark “STATOMIX”®. Other containers and mixers appropriate for the practice of the present invention will be readily evident to those skilled in the art.

Caulk and Colorant

As defined above, the caulk and colorant of the present invention comprise a wide range of materials. As will be evident to those skilled in the art, some caulks and colorants are more easily combined than others. For example, when using a caulk that is a sealant with a colorant that is a paint, the paint must be compatible with the sealant in order to mix with and tint the sealant. In particular examples, caulks such as those sold under the trade names GE XST Extreme Paintable Silicone II (GE Sealants & Adhesives, 16325 Northcross Dr., Huntersville, N.C. 28078), DAP® ALEX PLUS® (DAP Brands Company, 2628 Pearl Road, Medina Ohio 44256), and DYNAFLEX 230® Premium Elastomeric Latex Sealant (DAP Brands Company, 2628 Pearl Road, Medina Ohio 44256) can be mixed with any conventional water-based latex paints such as, for example, Valspar® American Tradition 100% Acrylic Latex Wall Paint (Valspar Sourcing, Inc., 1101 South Third Street, Minneapolis Minn. 55415), Behr Premium Plus® Latex Paint (Behr Process Corporation, 3400 W. Segerstrom Avenue, Santa Ana Calif. 92704), Cabot® Semi-Transparent Water-based Wood Stain 1300 Series (Samuel Cabot Incorporated, 100 Hale Street, Newburyport Mass. 01950), and Benjamin Moore® 1005 Acrylic Transparent Deck & Siding Stain (Benjamin Moore & Co., 51 Chestnut Ridge Road, Montvale N.J. 07631).

The ratio of the caulk to the colorant also enables the desired tint to be achieved. For example, a clear or translucent caulk may be used in a higher ratio to colorant than a white or grey caulk. Predetermined ratios of caulk to paint that are effective in the present invention are achieved by using the conventional containers described above.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. An apparatus for mixing a caulk with a colorant comprising:
a container containing a predetermined amount of a caulk and a predetermined amount of a colorant;
a mixer in fluid communication with the container;
a discharger to discharge the caulk and the colorant from the container into the mixer, the mixer mixing the caulk with the colorant such that the colorant tints the caulk as the caulk and the colorant pass through the mixer.

2. The apparatus of claim 1 wherein the mixer is a static mixer.

3. A method for mixing caulk with colorant comprising:
providing a container containing predetermined amount of a caulk and a predetermined amount of a colorant;
providing a mixer in fluid communication with the container;
discharging the caulk and the colorant from the container into the mixer;
mixing the caulk with the colorant as the caulk and the colorant pass through the mixer such that the colorant tints the caulk.

4. The method of claim 3 wherein the mixer is a static mixer.

5. An apparatus for mixing caulk with colorant comprising:
a first container having a predetermined amount of caulk provided therein;
a second container having a predetermined amount of colorant provided therein;
a mixer in fluid communication with the first container and the second container;
a discharger to discharge the caulk and the colorant from the first container and the second container into the mixer, wherein the caulk and the colorant are mixed such that the colorant tints the caulk as the caulk and the colorant pass through the mixer.

6. A method for mixing caulk with colorant comprising:
providing a predetermined amount of caulk in a first container;
providing a predetermined amount of colorant in a second container;
providing a mixer in fluid communication with the first container and the second container;
discharging the caulk and the colorant from the first container and the second container into the mixer;
mixing the caulk and the colorant as the caulk and the colorant pass through the mixer such that the colorant tints the caulk.

7. An apparatus for mixing caulk with colorant comprising:
a first container having a predetermined amount of caulk provided therein;
a second container having a space into which a predetermined amount of colorant is placed;
a mixer in fluid communication with the first container and the second container;
a discharger to discharge the caulk and the colorant from the first container and the second container into the mixer, wherein the caulk and the colorant are mixed such that the colorant tints the caulk as the caulk and the colorant pass through the mixer.

8. The apparatus of claim 7 wherein the first container and the second container each has an outlet opening, the mixer being in fluid communication with the outlet openings.

9. A method for mixing caulk with colorant comprising:
providing a predetermined amount of caulk in a first container;
placing a predetermined amount of colorant in a second container;
providing a mixer in fluid communication with the first container and the second container;
discharging the caulk and the colorant from the first container and the second container into the mixer;
mixing the caulk and the colorant as the caulk and the colorant pass through the mixer such that the colorant tints the caulk.

10. An apparatus for mixing caulk with colorant comprising:
at least two containers, each of the at least two containers having an outlet opening;
a caulk provided in a first of the at least two containers;
a colorant provided in a second of the at least two containers;
a mixer in fluid communication with the outlet openings of the at least two containers;
a discharger to discharge the caulk and the colorant from the at least two containers into the mixer, wherein the caulk and the colorant are mixed such that the colorant tints the caulk as the caulk and the colorant pass through the mixer.

11. A method for mixing caulk with colorant comprising:
providing an apparatus having at least two containers, each of the at least two containers having an outlet opening;
providing a caulk in a first of the at least two containers;
providing a colorant in a second of the at least two containers;
providing a mixer in fluid communication with the outlet openings of the first and the second containers;
discharging the caulk and the colorant from the first and the second containers through the outlet openings into the mixer;
mixing the caulk and the colorant as the caulk and the colorant pass through the mixer such that the colorant tints the caulk.

12. An apparatus for mixing caulk with colorant comprising:
at least two containers, each of the at least two containers having an outlet opening;
a caulk provided in a first of the at least two containers;
a second of the at least two containers, the second container having a space into which a colorant is placed;
a mixer in fluid communication with the outlet openings of the at least two containers;
a discharger to discharge the caulk and the colorant from the at least two containers into the mixer, wherein the caulk and the colorant are mixed such that the colorant tints the caulk as the caulk and the colorant pass through the mixer.

13. A method for mixing caulk with colorant comprising:
providing an apparatus having at least two containers, each of the at least two containers having an outlet opening;
providing a caulk in a first of the at least two containers;
placing a colorant in a second of the at least two containers;
providing a mixer in fluid communication with the outlet openings of the first and the second containers;
discharging the caulk and the colorant from the first and the second containers through the outlet openings into the mixer;
mixing the caulk and the colorant as the caulk and the colorant pass through the mixer such that the colorant tints the caulk.

14. An apparatus for mixing caulk with colorant comprising:
an apparatus having an outer container;
an inner container concentric to the outer container;
the outer container and the inner container each having an outlet opening, the outlet opening of the inner container positioned within the outlet opening of the outer container;
a piston placed within the outer container;
a caulk provided within the outer container;
a colorant placed within the inner container;
a mixer connected to the outlet opening of the outer container;
the caulk mixing with the colorant as the caulk and the colorant pass through the mixer when the piston is moved along the outer container and discharges the caulk and the colorant into the mixer.

15. A method for mixing caulk with colorant comprising:
providing an apparatus having an outer container;
providing an inner container concentric to the outer container;
the outer container and the inner container each having an outlet opening, the outlet opening of the inner container positioned within the outlet opening of the outer container;
placing a piston within the outer container;
providing a caulk within the outer container;
placing a colorant within the inner container;
providing a mixer in fluid communication with the outlet opening of the outer container;
mixing the caulk with the colorant as the caulk and the colorant pass through the mixer when the piston is moved along the outer container and discharges the caulk and the colorant into the mixer.

16. An apparatus for mixing caulk with colorant comprising:
a first container and a second container, the second container being inside the first container;
the first and second containers having hollow interiors;
a plunger being slidably mounted within the interior of the first container;
an elongated post extending from the plunger moveable into the second container upon movement of the plunger into the first container;
each of the containers having an outlet through which the respective caulk and colorant are discharged upon movement of the plunger into the first container and the post into the second container;
a mixer in fluid communication with the outlets of the first and second containers for receiving the caulk and the colorant upon discharge from the respective containers;
the mixer mixing the caulk and the colorant as the caulk and the colorant pass through the mixer such that the colorant tints the caulk.

17. A method for mixing a caulk with a colorant comprising:
providing an apparatus having first and second containers having hollow interiors, each of the containers having an outlet opening;
slidably placing a plunger into the hollow interior of the first container;
mounting an elongated post on the plunger such that the post moves into the hollow interior of the second container upon movement of the plunger into the first container;
providing a caulk in the first container;
placing a colorant in the second container;
providing a mixer in fluid communication with the outlets of the first and second containers for receiving the caulk and the colorant upon discharge from the respective containers;
discharging the caulk and the colorant from the first and second containers into the mixer by slidably moving the plunger into the first container and the post into the second container;
mixing the caulk and the colorant as the caulk and the colorant pass through the mixer such that the colorant tints the caulk.

18. An apparatus for mixing a caulk with a colorant comprising:
a container containing a predetermined amount of a caulk and a predetermined amount of a colorant;
a static mixer in fluid communication with the container;
a discharger to discharge the caulk and the colorant from the container into the static mixer, the static mixer mixing the caulk with the colorant such that the colorant tints the caulk as the caulk and the colorant pass through the static mixer.

19. A method for mixing caulk with colorant comprising:
providing a container containing predetermined amount of a caulk and a predetermined amount of a colorant;
providing a static mixer in fluid communication with the container;
discharging the caulk and the colorant from the container into the static mixer;
mixing the caulk with the colorant as the caulk and the colorant pass through the static mixer such that the colorant tints the caulk.

20. An apparatus for mixing caulk with colorant comprising:
a first container having two compartments, the first compartment having a predetermined amount of resin provided therein, and the second compartment having a predetermined amount of curing agent provided therein, the resin and the curing agent forming the caulk when mixed;
a second container having a predetermined amount of colorant provided therein;
a mixer in fluid communication with the first container and the second container;
a discharger to discharge the resin, the curing agent, and the colorant from the first container and the second container into the mixer, wherein the resin, the curing agent, and the colorant are mixed such that the colorant tints the caulk as the caulk and the colorant pass through the mixer.

21. A method for mixing caulk with colorant comprising:
providing a first container having two compartments, the first compartment having a predetermined amount of resin provided therein, and the second compartment having a predetermined amount of curing agent provided therein, the resin and the curing agent forming the caulk when mixed;
providing a second container having a predetermined amount of colorant provided therein;
providing a mixer in fluid communication with the first container and the second container;
discharging the resin, the curing agent, and the colorant from the first container and the second container into the mixer;
mixing the resin and the curing agent with the colorant as the resin, the curing agent, and the colorant pass through the mixer such that the colorant tints the caulk.
